(19) United States
(12) Patent Application Publication
(10) Pub. No.: US 2018/0010014 A1
(43) Pub. Date: Jan. 11, 2018

(54) COMPOSITIONS FOR ADHESIVE APPLICATIONS

(71) Applicant: Zephyros, Inc., Romeo, MI (US)

(72) Inventors: David E. Sweet, Washington, MI (US); Michael J. Czaplicki, Rochester, MI (US); Kevin Hicks, Harrison Township, MI (US); Austin O'Connor, Washington, MI (US); Yuan Lu, Troy, MI (US)

(21) Appl. No.: 15/646,843

(22) Filed: Jul. 11, 2017

Related U.S. Application Data
(60) Provisional application No. 62/360,668, filed on Jul. 11, 2016.

(51) Int. Cl. C09J 5/06; B05D 1/28; F16L 9/127; B05D 1/02; B05D 1/18; F16L 13/10; C09J 135/04

(52) U.S. Cl. CPC C09J 5/06; B05D 1/18; B05D 1/28; F16L 13/103; F16L 9/127; B05D 1/02; C09J 135/04; C09J 2201/61; C09J 2205/302; C09J 2427/006; C09J 2433/00; C09J 2203/10

(57) ABSTRACT

The present teachings contemplate a method comprising coating a poly(vinyl chloride) material with a composition including a dicarbonyl compound, a cyanoacrylate compound, or a combination thereof and a viscosity modifying agent so that the composition has a viscosity of from about 50 cps to about 2500 cps; wherein the coated poly(vinyl chloride) material is capable of adhering to a second material without the use of a primer.

### TECHNICAL FIELD

The present invention relates generally to cement adhesive compositions for use with polyvinylchloride piping.

### BACKGROUND

In the construction industry, among others, polymeric adhesives, sealants and foams are used to provide a sealing function. Primers (e.g., solvents) or the like are frequently utilized in conjunction with such materials. However, the additional primer step adds processing time and materials to a bonding operation. In addition, the use of such primers presents significant challenges in that they may require specialized processing due to toxicity of the materials. Often, primers may emit volatile organic compounds (VOCs).

U.S. Pat. Nos. 8,609,885; 8,884,051; and 9,181,365 and U.S. Publication Nos. 2014/0329980 and 2015/0056879 may be relevant to the present teachings, and are all incorporated by reference for all purposes.

Notwithstanding the above teachings, there remains a need for an adhesive for adhering to poly(vinyl chloride) (PVC) without the need for a primer. There is a further need for adhesives that do not emit toxic VOCs nor require the use of primer that emits VOCs.

### SUMMARY OF THE INVENTION

One or more of the above needs are met by the present teachings which contemplate a method comprising coating a poly(vinyl chloride) material with a composition including a dicarbonyl compound, a cyanoacrylate compound, or combinations thereof, and a viscosity modifying agent so that the composition has a viscosity of from about 50 cps to about 2500 cps; wherein the coated poly(vinyl chloride) material is capable of adhering to a second material without the use of a primer.

The coating step may initiate spontaneous polymerization (e.g., in less than about one minute) at room temperature of the composition without the addition of an initiator.

The second material may also be a poly(vinyl chloride). The coating step may comprise applying a film to the poly(vinyl chloride) material. The coating step may include spray coating, roll coating, brushing, dipping or any combination thereof. The composition may form a handling film. Polymerization of the composition may occur at least 5 minutes, at least 15 minutes or even at least 30 minutes after coating. Polymerization of the composition may occur less than 1 hour, less than 30 minutes, less than 15 minutes, or even less than 5 minutes after coating. The composition may be stored in a container formed from one or more materials having a pH of less than 7. The composition may be formed as a paste. The composition may include a colorant. The poly(vinyl chloride) material may be a poly(vinyl chloride) pipe and the second material may be a poly(vinyl chloride) pipe. The poly(vinyl chloride) pipes may be connected via a pipe fitting in contact with the composition. The composition may be de-bonded and removed from the poly(vinyl chloride) material. The composition may be formed for locating into a glue gun application device. The composition may be stored in a polyethylene container. The composition may form a tack-free surface on the poly(vinyl chloride) material. The method may include heating the composition on the substrate to cause adhesion of the composition to the poly vinyl chloride material and/or the second material.

The teachings herein further provide for a structure comprising a first poly(vinyl chloride) pipe, a composition including a dicarbonyl compound, a cyanoacrylate compound, or combinations thereof coated onto the poly(vinyl chloride) pipe and a pipe fitting for connecting to a second poly(vinyl chloride) pipe, wherein the structure is free of any primer material.

### DETAILED DESCRIPTION

The present teachings meet one or more of the above needs by the improved composite structures and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing dates of U.S. Provisional Application No. 62/360,668, filed Jul. 11, 2016. The entirety of the contents of this application is hereby incorporated by reference for all purposes.

The present teachings contemplate the use of a monomeric composition (e.g., and adhesive composition), for coating a poly(vinyl chloride) substrate. The monomeric composition may include a cyanoacrylate compound, a dicarbonyl compound, or combinations thereof. The composition may be a one part material that polymerizes either immediately or at some later designated time at room temperature. It is quite possible that the monomeric composition polymerizes at room temperature without the addition of any initiator or stimulus. However, it is also possible that an initiator or stimulus may be utilized to cause polymerization of the composition. The composition may be such that the time of polymerization can be modified so that it is “on demand”. In other words, the composition can be applied as a coating to a secondary material and provide sufficient open time for application of the coating with no polymerization such that the composition does not polymerize until contact with a substrate of choice. Thus, open time for the application process can extend a number of minutes or even an hour without fear of early polymerization. It is possible that only contact with certain substrates initiates polymerization of the composition.

The composition may provide one or more of the following benefits. The composition may form a tack-free surface on an otherwise tacky material. The composition may securely adhere without the use of any primer material. The composition may adhere a plurality of poly(vinyl chloride) pipes together via a pipe fitting. The composition may undergo polymerization at room temperature with no additional initiator or stimulus. The composition may allow for de-bonding of the pipes from one another. The composition may be contacted by a pre-selected stimulus for de-bonding the pipes from one another. The composition may provide sufficient adhesion between materials that typically require primers for sufficient adhesion.

The composition may be applied directly to a poly(vinyl chloride) material. The composition may alternatively applied to a secondary material which is thereafter applied to the poly(vinyl chloride) material. Immediate polymerization at room temperature may occur when the composition is applied to the poly(vinyl chloride) material. It is also possible that that the composition may polymerize via electropolymerization, mechanically initiated polymerization, dual cure polymerization, thermally initiated polymerization, coordination polymerization, or nucleophilic polymerization. The composition may undergo solution or emulsion polymerization. It is also possible that the composition undergoes random copolymerization or block copolymerization.

The compositions taught herein may provide for improved processability as compared to typical PVC cement/primer processes. The adhesive composition may provide improved mechanical properties such as increased tensile strength, improved modulus, improved hardness, increase impact strength, increased UV stability and improved crystallinity. The adhesive composition may provide improved barrier capabilities against oxygen, carbon dioxide, water and other substances. The adhesive composition may have improved rheology, ductility and elasticity. The adhesive compositions may have improved thermal characteristics and higher heat distortion temperatures.

It is possible that contact between the adhesive compositions described herein and the poly(vinyl chloride) materials may cause polymerization of the adhesive compositions. Certain basic substrates (e.g., those having a pH of greater than 7) may cause polymerization (and thus possibly adhesion) of the adhesive composition, which may thus adhere the PVC to a second material (which may also be a PVC material).

In order to obtain an adhesive composition with sufficient viscosity to be applied in a desired location without significant dripping, a viscosity modifying agent may be supplied. The viscosity modifying agent may be selected from one or more filler materials, which may be selected from fumed silica, polymethylmethacrylate (PMMA), sulfonated polymers, carboxylated polymers, polymer fibers, surface modified silica and combinations thereof.

The adhesive compositions may be utilized in the formation of a paste, a film, a tape (which may be pressure sensitive), or any material requiring differential tack. The compositions may be utilized to form weldable materials. The adhesion capability of the coating compositions may be modified by raising the molecular weight of the coating composition. Adhesion may occur upon initiation but may also be delayed post-initiation.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method comprising coating a poly(vinyl chloride) material with a composition including:
one or more of a dicarbonyl compound, a cyanoacrylate compound, or combinations thereof; and
a viscosity modifying agent so that the composition has a viscosity of from about 50 cps to about 2500 cps;
wherein the coated poly(vinyl chloride) material is capable of adhering to a second material without the use of a primer.

2. The method of claim 1, wherein the poly(vinyl chloride) material is a pipe.

3. The method of claim 1, wherein the second material is a poly(vinyl chloride) material.

4. The method of claim 1, wherein the coating step comprises applying a film to the poly(vinyl chloride) material.

5. The method of claim 1, wherein the coating step includes spray coating, roll coating, brushing, dipping or any combination thereof.

6. The method of claim 1, wherein polymerization of the composition occurs at least 5 minutes, at least 15 minutes or even at least 30 minutes after coating.

7. The method of claim 1, wherein polymerization of the composition occurs less than 1 hour, less than 30 minutes, less than 15 minutes, or even less than 5 minutes after coating.

8. The method of claim 1, wherein the poly(vinyl chloride) material and second material comprise poly(vinyl chloride) pipes which are adhered to one another via the composition and a pipe fitting.

9. The method of claim 1, wherein the composition is stored in a container formed of one or more materials having a pH of less than 7.

10. The method of claim 1, wherein the composition is formed as a paste.

11. The method of claim 1, wherein the composition includes a colorant.

12. The method of claim 1, wherein the coated polymeric material is de-bonded and removed from the substrate.

13. The method of claim 1, wherein the composition is formed for locating into a glue gun application device.

14. The method of claim 1, wherein the composition is stored in a polyethylene container.

15. The method of claim 1, wherein the coating forms a tack-free surface on the poly(vinyl chloride) material.

16. The method of claim 1, including heating the composition to cause adhesion of the composition and/or polymeric material to the substrate.

17. The method of claim 1, wherein the viscosity modifying agent is selected from fumed silica, polymethylmethacrylate (PMMA), sulfonated polymers, carboxylated polymers, polymer fibers, surface modified silica and combinations thereof.

18. A structure comprising: a poly(vinyl chloride) pipe; a composition including a dicarbonyl compound, a cyanoacrylate compound, or combinations thereof coated onto the poly(vinyl chloride) pipe; and a pipe fitting for connecting to a second poly(vinyl chloride) pipe, wherein the structure is free of any primer material.

19. The structure of claim 18, wherein the composition is located onto the poly(vinyl chloride) material by spray coating, roll coating, brushing, dipping or any combination thereof.

20. The structure of claim 18, wherein the composition forms a film on the poly(vinyl chloride) material.
